(19) United States
(12) Patent Application Publication
(10) Pub. No.: US 2009/0217017 A1
(43) Pub. Date: Aug. 27, 2009

(54) METHOD, SYSTEM AND COMPUTER PROGRAM PRODUCT FOR MINIMIZING BRANCH PREDICTION LATENCY

(75) Inventors: Khary J. Alexander, Poughkeepsie, NY (US); David S. Hutton, Tallahassee, FL (US); Brian R. Prasky, Wappingers Falls, NY (US); Anthony Saporito, Highland, NY (US); Robert J. Sonnelitter, III, Wappingers Falls, NY (US); John W. Ward, III, Pflugerville, TX (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/037,137

(22) Filed: Feb. 26, 2008

(51) Int. Cl. G06F 9/30

(52) U.S. Cl. 712/241; 712/E09.016

(57) ABSTRACT

A method, system, and computer program product for minimizing branch prediction latency in a pipelined computer processing environment are provided. The method includes detecting a branch loop utilizing branch instruction addresses and corresponding target addresses stored in a branch target buffer (BTB). The method also includes fetching the branch loop into a pre-decode instruction buffer and qualifying the branch loop for loop lockdown. The method further includes locking an instruction stream that forms the branch loop in the pre-decode instruction buffer and processing qualified branch loop instructions from the buffer and powering down instruction fetching and branch prediction logic (BPL) associated with the BTB.

### BACKGROUND OF THE INVENTION

This invention relates generally to branch prediction, and more particularly to a method, system, and computer program product for minimizing branch prediction latency in a pipelined computer processing environment.

Branch prediction logic (BPL) is employed to increase the efficiency of pipelined microprocessors. A Branch Target Buffer (BTB) searches ahead of instruction fetching to find and predict instruction stream altering instructions (e.g., taken branches). This detection is based on learned history of both direction and target of branches at specific addresses. There is an inherent latency between the detection of the need to redirect and the ability to satisfy this need, which involves lookup of the address and fetching of the new (non-sequential) instruction stream. Ideally, this latency is hidden in the time it takes to get to the branch point along the sequential stream, but it can be exposed in a number of scenarios, e.g., fetch for target cache line misses. Another cause of exposure is tight branch loops where the time of the short sequential instruction stream is less than the time to successively predict a branch, fetch the target, and redirect the instruction stream.

What is needed, therefore, is a way to provide branch prediction processes while minimizing latency issues typically associated with existing branch predictors.

### BRIEF SUMMARY OF THE INVENTION

An exemplary embodiment includes a method of minimizing branch prediction latency in a pipelined computer processing environment. The method includes detecting a branch loop, utilizing a branch instruction address and corresponding target addresses stored in a branch target buffer (BTB) and taken-queue. The method also includes qualifying the branch loop for loop lockdown and locking an instruction stream comprising the branch loop in the pre-decode instruction buffer once fetched in response to the branch prediction redirect. The method further includes processing qualified branch loop instructions from the pre-decode instruction buffer and powering down instruction fetching and branch prediction logic (BPL) associated with the BTB.

Further exemplary embodiments include a system and computer program product for minimizing branch prediction latency in a pipelined computer processing environment.

### BRIEF DESCRIPTION OF THE DRAWINGS

Referring now to the drawings wherein like elements are numbered alike in the several FIGURES:

FIG. 1 is a block diagram illustrating a system upon which branch prediction with loop lockdown processes may be implemented in accordance with an exemplary embodiment; and

FIG. 2 is a flow diagram illustrating normal branch prediction operations, loop acquire functions, lockdown mode operations, and related interactions among the components of the system of FIG. 1, in accordance with an exemplary embodiment.

### DETAILED DESCRIPTION OF EXEMPLARY EMBODIMENTS

In accordance with an exemplary embodiment, a branch loop detection and lock in scheme is provided. The branch loop detection and lock in processes detect branch loops, lock in on these loops with respect to a pre-decode instruction buffer, and the instruction stream is exclusively read out of the buffer (which eliminates the need to continually fetch this loop), thereby improving system performance and reducing power consumption of the overall processing system.

In particular, instructions are fetched from cache memory and are stored into one or more Super Basic Block Buffer (SBBB) elements. Through the use of this buffering, an applied branch target buffer (BTB) can detect fetch taken branch targets ahead of sequential delivery to an instruction decode unit (IDU) and have them buffered up as to create a 0 cycle branch to target redirect. By extension, the recognition of branch loops, which can be fully contained within the SBBB(s), facilitates the locking down of the instruction streams within the SBBB. Once locked into the SBBB, there is no longer a need to continually fetch this loop, and instead its content is repeatedly read out of the SBBB, thereby delivering the instruction text with no latency for the tightest of loops.

Power savings are obtained from reducing, if not totally eliminating, activity through the branch prediction search and instruction cache (ICache) fetch hierarchy and the ability to conserve power in the controls in those and associated areas. Again, once the stream has been locked into the SBBBs where they can be read and delivered to the IDU a plurality of times, there is no need to continue to predict and fetch the loop contents. When combined, these improvements enable the design of microprocessors with higher performance and greater efficiencies.

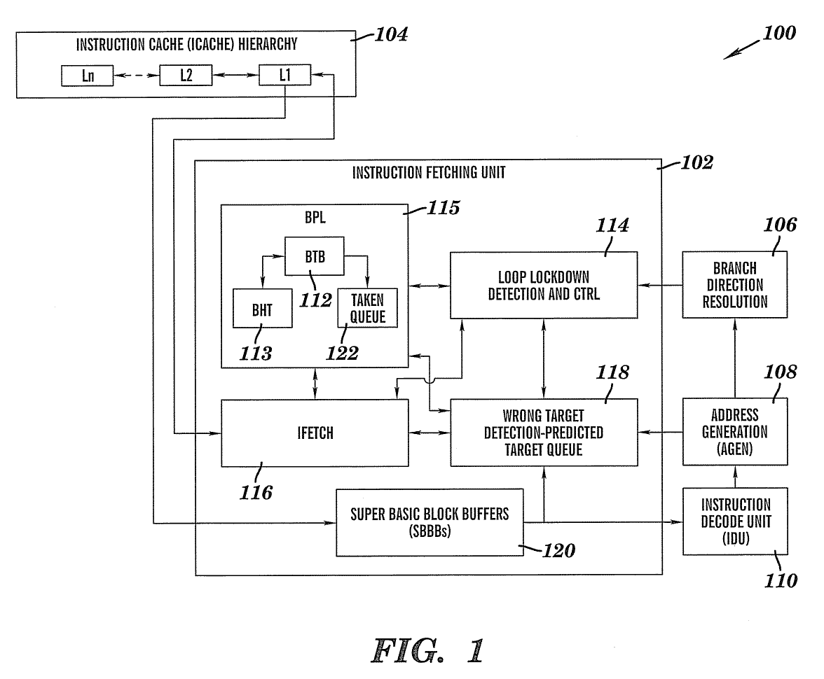

Turning now to FIG. 1, a block diagram illustrating a processing system 100 upon which branch prediction with loop lockdown processes may be implemented in accordance with an exemplary embodiment will now be described. The processing system 100 (processor) may be implemented by hardware and/or software instructions including firmware or microcode. The processor 100 of FIG. 1 includes an instruction fetching unit (IFU) 102 in communication with an instruction cache (I-cache) 104, a branch direction resolution unit 106, an address generation (AGEN) unit 108, and an instruction decode unit (IDU) 110.

The IFU 102 fetches instructions (via an instruction fetching (I-Fetch) component 116) by requesting cache lines from the L1 I-cache 104 and the cache 104 returns the content to a pre-decode instruction buffer, which is shown in FIG. 1 as a Super Basic Block Buffer (SBBB) 120.

I-Cache 104 refers to instruction cache memory local to one or more CPUs of the processing system 100 and may be implemented as a hierarchical storage system with varying levels of cache, from fastest to slowest (e.g., L1, L2, . . . ,Ln).

The SBBB 120 is an instruction text storage and sequencing element utilized between Ifetch 116 and the IDU 110. Through the use of this buffering, an applied BTB 112 of the IFU 102 can fetch branch targets ahead of sequential delivery to the IDU 110 and have them buffered up as to create a 0 cycle branch to target redirect. By extension, the recognition of branch loops, which can be fully contained within the SBBB 120, facilitates the locking down of the instruction streams within the SBBB 120. Once locked into the SBBB 120, there is no longer a need to continually fetch this loop, and instead the content is repeatedly read out of the SBBB 120, thereby delivering the instruction text with no latency for the tightest of loops. The Instruction fetching Unit (IFU) 102 continues in this mode until a break event occurs, e.g., branch wrong, exception condition, etc. Upon detection of the break event, the SBBB(s) 120 is unlocked and the normal branch prediction logic's (BPL's) 115 searching and I-Fetching resume at the new program instruction address.

The branch prediction logic (BPL) 115 includes a branch history table 113 (BHT), a branch target buffer (BTB) 112, and a taken queue 122. The BHT 113 allows for direction guessing of a branch based on the past behavior of the direction the branch previously went as a function of the branch address. If the branch is always taken, as is the case of a subroutine return, then the branch will be guessed as taken. The BTB 112 stores branch instruction addresses and their target addresses and searches this for the next instruction address that contains a branch. On a branch prediction hit, the target address is provided to IFetch 116 for fetching the new target stream and is also stored in the taken queue 122, which is described further herein.

The following components of FIG. 1 are defined below.

Loop Lockdown Detection & Control 114. The Loop Lockdown Detection & Control 114 works in conjunction with the BTB 112 and taken-queue 122 to detect branch loops represented by consecutive taken-queue predictions. Upon detection, a loop acquire (buffering) and lockdown mode is entered.

Instruction Decode Unit (IDU) 110 is a component of the processing system 100 that decodes instructions from the I-Cache 104. This decode includes determining required sources for operand address generation.

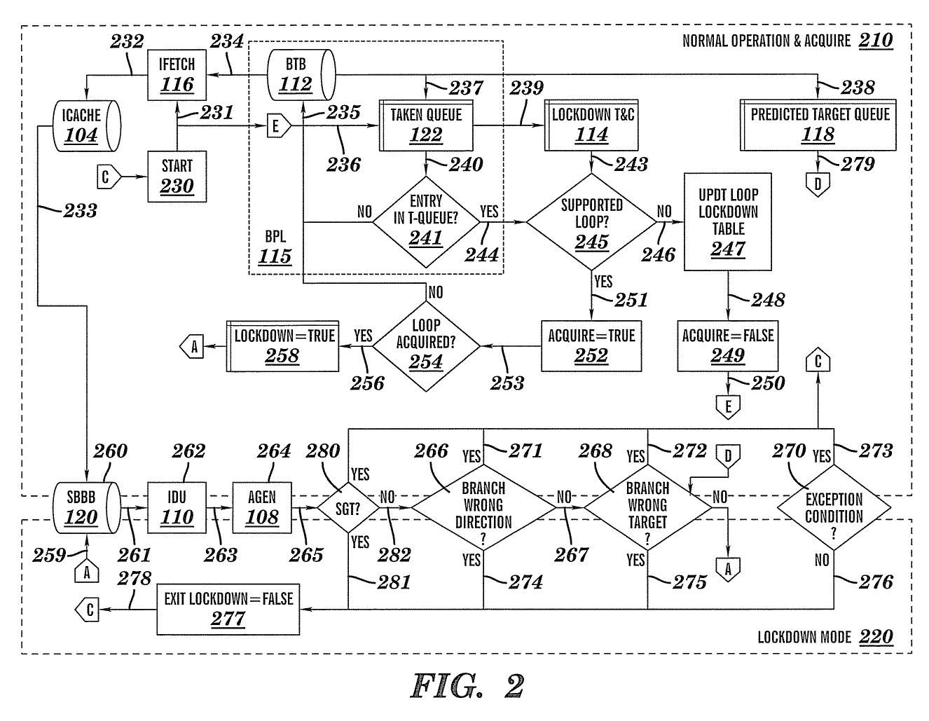

Address Generation (AGEN) 108. Operand addresses, including the actual target addresses of branches, are calculated in this stage. This enables wrong target determination, as described further in FIG. 2.

Wrong Target Detection—Predicted Target Queue 118. A loop can be naturally exited when the target addresses of one of the taken branches in a loop changes. This is detected by the wrong target detection logic in conjunction with the predicted target queue 118. The predicted target address of a branch (obtained from the BTB 112 as described above) is compared against the AGEN 108 generated target address. If there is a miscompare, then the target address utilized for a taken branch was incorrect and now determined to be incorrect target stream is blown away and the IFU 102 restarts at the correct target address.

Branch Direction Resolution 106. A loop can also be naturally exited when the direction of one of the branches in the loop changes direction. This is detected by branch resolution logic 106, which compares the guessed direction of the branch and the actual resolution via an execution unit. An example of this is the previously taken branch at the end of a loop resolving non-taken signifying that the sequential stream, after the branch, should be followed instead of taking the branch back to the beginning of the loop.

Turning now to FIG. 2, a flow diagram illustrating normal branch prediction operations, loop acquire functions, and lockdown mode operations, in conjunction with the various components of the system of FIG. 1, will now be described in accordance with an exemplary embodiment. In an exemplary embodiment, the processing depicted in FIG. 2 is performed by hardware and/or software, such as firmware or microcode located on the processor 100 depicted in FIG. 1. Normal operations and acquire mode functions are shown in block 210. Lockdown mode operations are shown in block 220. All processing elements in block 210 occur under normal (non-locked down) operation. Those that do not overlap into the lockdown block of 220 are placed into various levels of power save mode. The elements that span both blocks are utilized in both modes, as they are necessary to continue the processing of the loop's instruction stream and detecting the right point to exit the loop and lockdown.

The process begins at block 230 after some reset event, whereby instructions are fetched from the I-Cache 104 and are stored into the SBBB 120, as shown by arrows 231-233 via I-Fetch logic 116. The instruction fetching address is, in parallel, used to index the BTB 112 and the Taken queue 122 via paths 235 and 236 respectively. The BTB 112 contains an index of branch addresses and their associated target addresses. If there is a hit on a predicted taken branch, its target address is delivered to I-fetch 116 to fetch the target stream into the SBBB 120. Through the use of this buffering, the BTB 112 can fetch branch targets ahead of sequential delivery to the IDU 110 and have them buffered up as to create a 0 cycle branch to target redirect, as described herein. Taken-queue 122 maintains recently encountered taken branches, which are also contained within the BTB 112 (but can be accessed faster than the BTB 112), and is utilized to detect repeating patterns in the current instruction stream. The taken-queue 122 and the predicted target queue 118 are updated via path 237 on BTB 112 hits.

The normal operations and acquire mode 210 implement logic provided by the Loop Lockdown & Control 114 to identify any patterns with respect to the instructions, as will now be described. In particular, the taken queue 122 is accessed (as shown by arrow 236) and, at decision block 241/arrow 240, it is determined whether the queue 122 contains the instruction. If so, the Lockdown Detection & Control 114 determines whether a loop that can be supported in lockdown mode exists, as shown in decision block 245 and arrows 239, 243, and 244. If a repeated taken queue pattern is encountered without a new non-taken-queue prediction being made from the BTB 112 in between taken queue predictions, then a branch pattern has been detected, as shown by arrow 251.

If this pattern of one or more qualifying taken branches in the taken queue is repeated a configurable number of times, loop lockdown mode may be entered, as will be described farther herein.

In order to support locking down the fetching and prediction front-end of the IFU 102, the post-IFetch SBBBs 120 need to be able to accommodate the entire stream/loop in the IFU 102. This involves two variables that are considered by the Loop Lockdown Detection & Control 114: the number of branches and total length of the branch loop.

Number of branches. SBBBs 120 can only be able to support a maximum number of branches individually and collectively. An IFU with a number (#B) of SBBBs that can each support a maximum number (#b) of taken branches will support Lockdown on patterns involving up to #B*#b taken branches. If a loop pattern has up to this number of taken branches, then loop lockdown mode may be entered.

Similarly, the SBBB structures will each only support a maximum amount of instruction text allowing the locking down of loops with total lengths up to the combined capacity the SBBBs. The total length of the loop may be determined by calculating and summing the length of each segment supported by comparing distances between taken branch (x) target and next taken branch (x+1) including the length of the ending taken branch (x+1).

Once these two conditions are detected and satisfied (as shown in block 252, decision block 254, and by arrows 253 and 256) the Loop Lockdown acquire mode may be entered. The process stays in “Acquire” mode until the loop is acquired and progress via path 256 or “Acquire” mode is exited at block 249.

Turning back to decision block 245, if a loop is not detected, a loop lockdown table is updated to reflect this in block 247, and as shown by arrow 246. The loop lockdown acquire mode is considered false, and the process continues to search the BTB 112 and taken-queue 122, respectively, in block 249 and arrows 248 and 250.

The acquire mode, initiated at block 252, is the first step of entering loop lockdown mode in which IFU 102 processing continues as the loop's branches are predicted and the instruction stream is fetched, except that the SBBB 120 contents are retained even after delivery to the IDU 110. Another characteristic of this mode is that the post decode branch tracking mechanisms are informed to also retain the information necessary to process the last loop-depth (n) branches. An example of this post decode branch tracking is the predicted target queue 118 utilized for predicted branch wrong target detection. As mentioned above, the addresses used to fetch the targets of predicted branches read from the BTB 112 are also stored in the predicted target queue 118. It is possible that the predicted target of a branch is incorrect and, as a result, detecting this and restarting at the correct target is required. The correct target is calculated in the Address Generation (AGEN) 108 stage of block 264 and compared against the predicted target address in the Predicted Target Queue 118 at block 268.

Once the instruction text and necessary branch information has been acquired and locked, the IFU 102 enters full lockdown mode, as shown by arrows 256, 259 and in block 258. In this mode, instruction fetching 116, branch prediction 112 and associated logic (BPL) 115 are powered down. There is no need to fetch the stream changing instructions as they are locked in the SBBBs 120, removing any redirection latency and improving the overall CPI while processing this tight loop segment. The processor 100 operates in this highly efficient mode (i.e., blocks 260, 262, 264 and arrows 261, 263, and 265) until a loop exiting condition is detected, as will now be described.

Lockdown mode terminates when an event that breaks the sequence represented by the loop is observed. Examples of these are asynchronous exception conditions where the processor 100 redirects to an exception handler (as shown in decision block 270 and arrow 276).

Also, a program-store-compare (PSC) to an I-cache line contained within locked SBBB(s) 120 may occur with self-modifying code where an instruction within the loop modifies/stores to an address of one or more instructions within the loop and potentially changes the stream. Therefore, if the I-Cache 104 line represented within the locked down SBBB(s) 120 receives a PSC cross-interrogate (XI), lockdown mode is terminated, as shown in block 277 and by arrow 278.

Surprise guess taken (SGT) branch detection 280 also results in the exit of loop lockdown mode. This occurs when an a branch is not predicted by the BPL 115 and, by default, is detected in the IDU 110 and acted upon via path 281 after AGEN 108 which generates the restart target addresses. Where this event at decision block 280 does not occur, the next decision block 266 may be considered as shown by arrow 282 and as described below.

Another event that breaks the sequence represented by the loop includes a Branch Wrong, which may be one of two types: Branch Wrong Direction and Branch Wrong Target.

Branch wrong direction is where a previously not-taken/taken branch in the locked loop resolves taken/not-taken in the Branch Direction Resolution logic 106. This can occur, for instance, at the end of a loop where the last branch, which previously branched back to the beginning of the loop, is not taken as the program progresses past the loop. This event is shown in decision block 266 and by arrow 274. Where this event at decision block 266 does not yield a wrong direction resolution the next decision block 268 may be considered as shown by arrow 267 and as described below.

Branch wrong target may also occur and represents the case where the target address of one of the (n) taken branches in the loop changes. In general, and as described above, when a branch prediction event is detected, information including the target of taken branches from the BTB 112 is retained in the Predicted Target Queue 118, as shown by arrow 238. With the BPL 115 in power savings mode during lockdown, the repeated predicted targets of the loops taken branch(es) need to also be remembered. This “locking down” of the necessary tracking information occurs during the acquire state described above. In essence, entries are not removed from the queue as they would normally be during normal operation at the resolution timeframe of the branch, but are instead retained for future occurrences of the branch within the loop. As can be seen, each occurrence of the loop's taken branch(es) must have the same target to maintain the instruction stream represented by the loop. This information is then later compared with each occurrence of address generation (AGEN) 108 calculated target address of a predicted taken branch to confirm that the target stream that was predicted (via the BTB 112) and fetched in response to the redirect event was correct, as shown by arrow 279 and decision block 268. If there is a miscompare, then the target of the branch has changed and the loop is broken. Where this event at decision block 268 does not yield a wrong target resolution, processing continues to the SBBB 120 via path 259.

In each of these cases, instruction fetching and branch prediction is restarted at the new stream at block 230, as shown by arrows 271-273, 274-276 and 278.

While only a single instruction stream for a branch loop has been described herein for purposes of illustration, it will be understood by those skilled in the art that multiple branch loops may be processed by the loop locking processes of the invention. For example, nested branch loops may be fetched into the SBBB 120, whereby an outer loop of the nested branch loops is locked onto while an inner loop of the nested branch loops is unrolled via hardware within the SBBB 120.

An exemplary embodiment of the present invention provides branch loop detection and lock in processes that detect branch loops, lock in on these loops with respect to a SBBB, and read content exclusively read out of the buffer. The technical effects and benefits include reduced or eliminated processing latency whereby the loop instruction is not continuously fetched, thereby improving system performance and reducing power consumption of the overall processing system. In addition, power savings are obtained from reducing if not totally eliminating activity through the branch prediction search and instruction cache (ICache) fetch hierarchy and the ability to power gate controls in those and associated areas.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for minimizing branch prediction latency in a pipelined computer processing environment, comprising:
detecting a branch loop utilizing branch instruction addresses and corresponding target addresses stored in a branch target buffer (BTB);
fetching the branch loop into a pre-decode instruction buffer;
qualifying the branch loop for loop lockdown;
locking an instruction stream comprising the branch loop in the pre-decode instruction buffer; and
processing qualified branch loop instructions from the buffer and powering down instruction fetching and branch prediction logic (BPL) associated with the BTB.

2. The method of claim 1, wherein the processing continues until a break event is detected, the break event including at least one of:
an exception condition;
a surprise (non-predicted) taken branch;
a branch wrong direction;
a branch wrong target; and
other asynchronous events;
wherein the break event causes the instruction fetching and BPL to resume.

3. The method of claim 1, wherein a branch wrong target check is performed for each branch that occurs in the loop lockdown.

4. The method of claim 1, wherein qualifying the branch loop includes determining a maximum number of branches supported by an instruction fetch unit (IFU) of the processor, comprising: a maximum number of taken branches supported by a buffer multiplied by the number of buffers supported by the IFU.

5. The method of claim 4, wherein qualifying the branch loop further includes determining a total length of the loop by calculating and summing the length of each segment supported by comparing distances between taken branch (x) target and next taken branch (x+1) including the length of the ending taken branch (x+1).

6. The method of claim 1, wherein the pre-decode instruction buffer stores instructions used for processing both qualified branch loop instructions and non-qualified branch loop instructions.

7. The method of claim 1, further comprising:
fetching nested branch loops into the pre-decode instruction buffer;
wherein locking an instruction stream comprises locking onto an outer loop of the nested branch loops while unrolling an inner loop of the nested branch loops within the pre-decode instruction buffer.

8. A computer program product for minimizing branch prediction latency in a pipelined computer processing environment, the computer program product comprising:
a computer readable storage medium for storing instructions for executing branch prediction services, the branch prediction services comprising a method of:
detecting a branch loop utilizing branch instruction addresses and corresponding target addresses stored in a branch target buffer (BTB);
fetching the branch loop into a pre-decode instruction buffer;
qualifying the branch loop for loop lockdown;
locking an instruction stream comprising the branch loop in the pre-decode instruction buffer; and
processing qualified branch loop instructions from the buffer and powering down instruction fetching and branch prediction logic (BPL) associated with the BTB.

9. The computer program product of claim 8, wherein the processing continues until a break event is detected, the break event including at least one of:
an exception condition;
a surprise (non-predicted) taken branch;
a branch wrong direction;
a branch wrong target; and
other asynchronous events;
wherein the break event causes the instruction fetching and BPL to resume.

10. The computer program product of claim 9, wherein a branch wrong target check is performed for each branch that occurs in the loop lockdown.

11. The computer program product of claim 8, wherein qualifying the branch loop includes determining a maximum number of branches supported by an instruction fetch unit (IFU) of the processor, comprising: a maximum number of taken branches supported by a buffer, multiplied by the number of buffers supported by the IFU.

12. The computer program product of claim 11, wherein qualifying the branch loop further includes determining a total length of the loop by calculating and summing the length of each segment supported by comparing distances between taken branch (x) target and next taken branch (x+1) including the length of the ending taken branch (x+1).

13. The computer program product of claim 8, wherein the pre-decode instruction buffer stores instructions used for processing both qualified branch loop instructions and non-qualified branch loop instructions.

14. The computer program product of claim 8, further comprising instructions for implementing:
fetching nested branch loops into the pre-decode instruction buffer;
wherein locking an instruction stream comprises locking onto an outer loop of the nested branch loops while unrolling an inner loop of the nested branch loops within the pre-decode instruction buffer.

15. A system for minimizing branch prediction latency in a pipelined computer processing environment, comprising:
an instruction fetching unit in communication with an instruction cache, the instruction fetching unit including logic for implementing a method, the method includes:
detecting a branch loop utilizing branch instruction addresses and corresponding target addresses stored in a branch target buffer (BTB);
fetching the branch loop into a pre-decode instruction buffer;
qualifying the branch loop for loop lockdown;
locking an instruction stream comprising the branch loop in the pre-decode instruction buffer; and
processing qualified branch loop instructions from the buffer and powering down instruction fetching and branch prediction logic (BPL) associated with the BTB.

16. The system of claim 15, wherein the processing continues until a break event is detected, the break event including at least one of:
an exception condition;
a surprise (non-predicted) taken branch;
a branch wrong direction;
a branch wrong target; and
other asynchronous events;
wherein the break event causes the instruction fetching and BPL to resume.

17. The system of claim 16, wherein a branch wrong target check is performed for each branch that occurs in the loop lockdown.

18. The system of claim 15, wherein qualifying the branch loop includes determining a maximum number of branches supported by an instruction fetch unit (IFU) of the processor, comprising: a maximum number of taken branches supported by a buffer multiplied by the number of buffers supported by the IFU.

19. The system of claim 18, wherein qualifying the branch loop further includes determining a total length of the loop by calculating and summing the length of each segment supported by comparing distances between taken branch (x) target and next taken branch (x+1) including the length of the ending taken branch (x+1).

20. The system of claim 15, wherein the pre-decode instruction buffer stores instructions used for processing both qualified branch loop instructions and non-qualified branch loop instructions.
